(19) United States
(12) Patent Application Publication
(10) Pub. No.: US 2015/0161694 A1
(43) Pub. Date: Jun. 11, 2015

(54) Trustee Based Online Community

(71) Applicant: Neil I. HARRIS, Burnsville, NC (US)

(72) Inventor: Neil I. Harris, Burnsville, NC (US)

(21) Appl. No.: 14/411,601

(22) PCT Filed: Jul. 26, 2013
(86) PCT No.: PCT/US13/52336

§ 371 Date: Dec. 29, 2014

Related U.S. Application Data
(60) Provisional application No. 61/675,998, filed on Jul. 26, 2012.

(51) Int. Cl. G06Q 30/06

(52) U.S. Cl. CPC G06Q 30/0609; G06Q 30/0613

(57) ABSTRACT

A system for connecting individuals and business entities as members of an online community enables electronic communications and electronic commerce among the members. The system includes a trust account module and a membership module implemented by respective software. A database connected to the membership module records information regarding members of the online community. A plurality of trust accounts corresponding to members of the online community and implemented by the trust account module is established within the network, and funds within the trust accounts are accessible for disbursement only by a third party trustee.

### CROSS REFERENCE TO RELATED APPLICATIONS

This application claims priority to and incorporates entirely by reference herein U.S. Provisional Patent Application Ser. No. 61/675,998 filed on Jul. 26, 2012.

### FIELD OF THE INVENTION

The invention relates to the field of electronic commerce implemented within a secure electronic network of members within an online community.

### BACKGROUND

Electronic commerce permeates all areas of business throughout the world in modern culture. Individuals pay bills online, shop for goods and services via their favorite vendors' websites, and conduct numerous kinds of commercial transactions from their computers. Businesses provide advertising and shopping opportunities on the Internet, contact customers via email, and run entire businesses, including shipping and receiving, via web-based programs. Modern society is comfortable with electronic commerce, even when transactions involve utilizing a personal bank account.

One of the biggest problems with electronic commerce lies in the fact that customers and vendors within a transaction might not know each other and have few opportunities to test the credentials of the other. Certain kinds of websites provide survey results, comment blocks, ratings, and publicly available scores for either a business entity or even a customer (e.g., shoppers on Ebay® receive reliability ratings as well as vendors). These kinds of ratings, however, are typically based on very few experiences that an entity or member of the public has had with that individual or that vendor, and it is difficult to assess the reliability of this publicly accessible data. In terms of utilizing a personal bank account to engage in electronic commerce, therefore, transactions online would instill more confidence in an environment where every participating customer and every participating vendor has been previously vetted for financial and business credibility.

Another problem in consummating an electronic commerce transaction lies in the administration of personal banking cards and credit cards for payments. The financial institutions that provide debit card and credit card services typically charge the individual or business that is purchasing with the card as well as the vendor who receives payment with the card. These kinds of debit and credit cards accounts, therefore, are extremely expensive to use when the fees are considered on a global basis. Also, the cards may be subject to fraud, illegal use, or misuse in an online environment.

Finally, when an individual or a business utilizes a personal bank account debit card, a credit card, or even a direct debit from an account, these online transactions usually require repetitive data entry into the electronic commerce system. The purchaser, or customer, often has to re-type an account number, an authorization code, a PIN, and the like for every transaction. Utilizing a personal or business bank account or a personal or business credit card to engage in a financial transaction, therefore, carries no semblance of efficiency on the front end when the customer is “checking out” of a shopping experience. The vendor providing goods and services via electronic payment also misses out on true efficiency because these kinds of credit card and debit card transactions often take hours or even days to clear after posting. The vendor typically does not receive payment immediately because the bank providing the credit or debit card services tries to ensure that a proposed charge on the card can be supported by sufficient funds. These kinds of checks occur quickly and are subject to mistakes or fraudulent use so that vendors and/or banks involved in an electronic transaction may be subject to loss at any given time.

The field of electronic commerce presents a need for a system in which commercial transactions occur with minimal problems of insufficient funds to cover an electronic purchase and fraudulent use of electronically tracked funds. The field of electronic commerce would also benefit from better efficiencies in the way that the administrative side of online transactions are completed.

### BRIEF SUMMARY OF THE INVENTION

In the first embodiment, a system for connecting individuals and business entities as members of an online community connected via a computerized network enables electronic communications and electronic commerce among the members. The system includes a trust account module and a membership module implemented by respective software on at least one non-transitory computer readable medium in electronic communication with the computerized network. A database connected to the membership module records information regarding members of the online community. A plurality of trust accounts corresponding to members of the online community and implemented by the trust account module is established within the network, and funds within the trust accounts are accessible for disbursement only by a third party trustee.

A method of establishing a trust network for financial transactions among members of an online community includes the steps of (i) accepting members who have requested to join the online community; (ii) establishing a respective trust agreement for each accepted member, wherein the trust agreement appoints a third party trustee to hold funds on behalf of the member named in the trust agreement; (iii) creating a trust account in which legal title is held by said third party trustee on behalf of a member of the online community, said trust account governed by one of the respective trust agreements; (iv) receiving funds for depositing into said trust account; (v) disbursing funds from said trust account only to members of the online community and only by an authorization of said third party trustee.

### BRIEF DISCUSSION OF THE FIGURES

FIG. 1 is a schematic diagram of the flowchart for a membership software module for the system disclosed herein.

FIG. 2 is a schematic diagram of the flowchart for a trust account software module for the system disclosed herein.

FIG. 3 is a schematic diagram of the flowchart for an electronic transaction consummated by a third party trustee s disclosed herein.

### DETAILED DESCRIPTION

This disclosure utilizes certain terms, particularly legal terms, in their ordinary sense and in the broadest commonly used definitions. For example, an “online community” is a group of individuals and businesses who access a common computer system via credentials provided by an overarching entity who controls that system and its access. “Members” of the online community refer to those individuals and businesses maintaining accounts on the common computer system and interacting with other members within the community via communications protocols available through the system.

A significant term used throughout this disclosure is “trust” as in “trust account,” “trust agreement,” and “trustee.” This disclosure uses the concepts of “trusts” in a standard legal sense. A trust entails a separation of legal and equitable title to a property, such as a trust account or trust fund. A trustee holds legal title to the property and is solely authorized to handle, manage, and access the account (i.e., to disburse money from a funded trust account). The way in which the trustee manages the trust property, such as a trust account, is governed by a trust agreement. The trust agreement is a legal document that transfers the legal title of the trust property to a named trustee who manages the trust property on behalf of a beneficiary, who holds “equitable title.” While the beneficiary cannot take legal actions related to the trust property, the trust agreement spells out how the trustee must handle the legal actions related to the trust property for the benefit of the beneficiary. A beneficiary may request that certain actions be taken with a trust property, but the trustee is the only party with authorization to actually enact the request, subject of course to limitations set forth in a trust agreement. Trust agreements used in accordance with this invention entail all legal requirements set forth in an appropriate state's laws, depending on where this invention is being used.

It is significant that for purposes of this disclosure, a trustee associated with the online community described below is a third party trustee in that the trustee is not a typical member of the community. In one embodiment, the trustee is directly associated with the business that owns and operates the computerized system implementing the online community via a network. In this sense, the trustee may be a single trustee that serves all of the members (a.k.a. beneficiaries) who have trust accounts accessible via the system.

In other words, the system and method described herein present a new set of relationships for online and electronic commerce transactions. In a traditional online transaction, the relationship is between a consumer, a vendor, and a financial institution providing bank account, debit card, or credit card services. The consumer, or purchaser, must access the financial institution records, via a card or otherwise, to consummate a deal. As noted above, this entails typing in credit or debit card numbers, authorization codes, personal identification numbers, and the like. The vendor has the typical delays in receiving money as previously discussed.

In the system presented herein, the relationships are more secure because the commercial transactions occur within a finite, secure online community, referred to herein as a “trust network.” The online community is made of members, both businesses and individuals, who have been accepted into the community because of their solid financial, business, and personal credentials. These members also agree to relinquish control of certain amounts of money that fund trust accounts managed within the confines of the computerized system via a third party trustee. In one embodiment, the same trustee serves all of the members of the online community, or trust network, in handling the affairs of respective trust accounts.

By establishing individual trust accounts in an online community of qualified members, the system described herein removes significant risks involved in electronic commerce transactions. The trustee is a third party trustee who has the legal authority to disburse money from a trust, account or to deny a request for the money, based on the financial us of the trust account. A member who expects to be a recipient of money from another member's trust account can rely on the fact that if the trustee agrees to pay a certain amount to consummate a transaction on behalf of a beneficiary member, then the trust account has sufficient funds to complete the payment. The trustee can verify that the funds are in place in real time: therefore, the system disclosed herein is a secure way to ensure that a vendor, who is also a member of the online community, or trust network, will be properly paid.

The administration of paying for commercial transactions is also greatly simplified in the system of this invention. A member, who is the beneficiary of a respective trust account associated with the system, simply selects a purchase, a routine bill paying mechanism, or even a cash transfer to another member, and instructs the trustee of the respective trust account accordingly. In this sense, the member beneficiary of a trust account within the trust network only sends a simple instruction or order to the trustee. The member beneficiary does not type in credit card numbers or authorization codes. The member beneficiary simply instructs the trustee by a convenient mechanism (e.g., email or even online messaging). The system can also accommodate vendors within the community preparing pre-filled instructions for a trustee so that when a member beneficiary shops with a member vendor via the online community, the member beneficiary can utilize a convenient instruction mechanism to request a payment by the trustee. These instructions may be accessed by simply selecting a box on a menu, and the instructions are automatically sent, via the online community, to the appropriate trustee. The convenience of this kind of electronic commerce cannot be overstated. The fees will be minimal, which helps numerous individuals who cannot afford credit cards or do not maintain traditional banking accounts.

The system is characterized by using a third party trustee who has legal but riot equitable title to a trust fund and must use the trust fund only for the benefit of the member beneficiary of that trust fund. In this way, once a member joins the online community of the trust network and provides all of the objective information necessary to establish a trust agreement and open a trust account, that member does not have to enter that information ever again so long as the member conducts business with another member of the network. The trustee set-up is a one-time transaction.

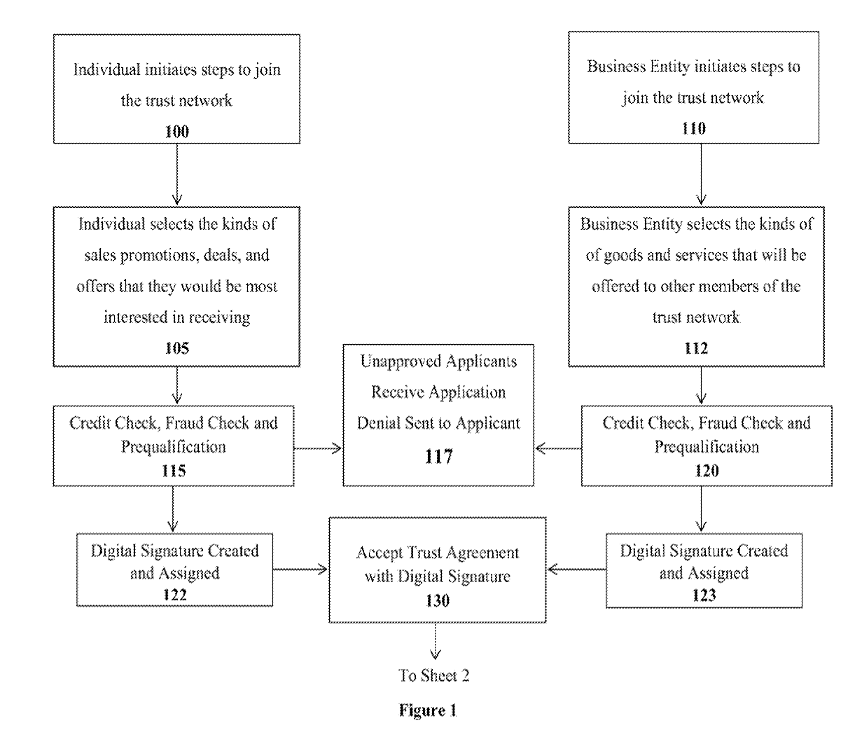

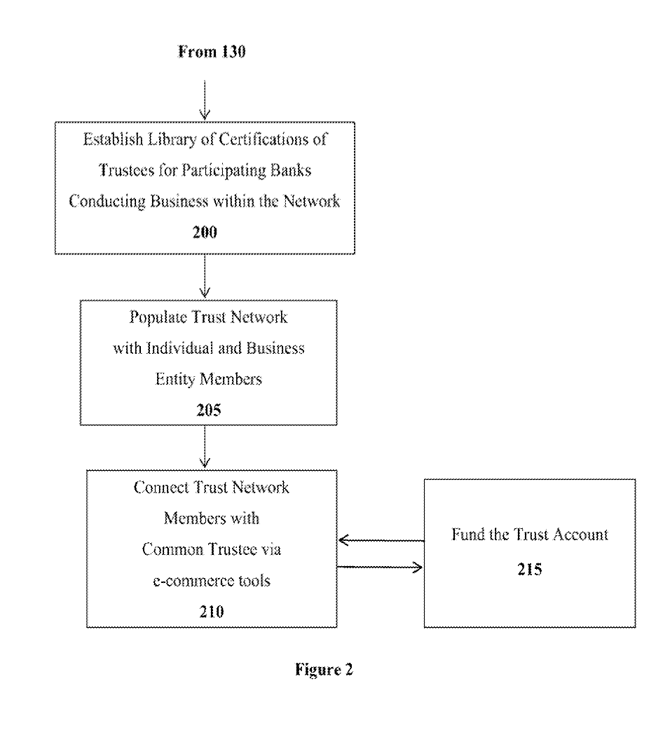

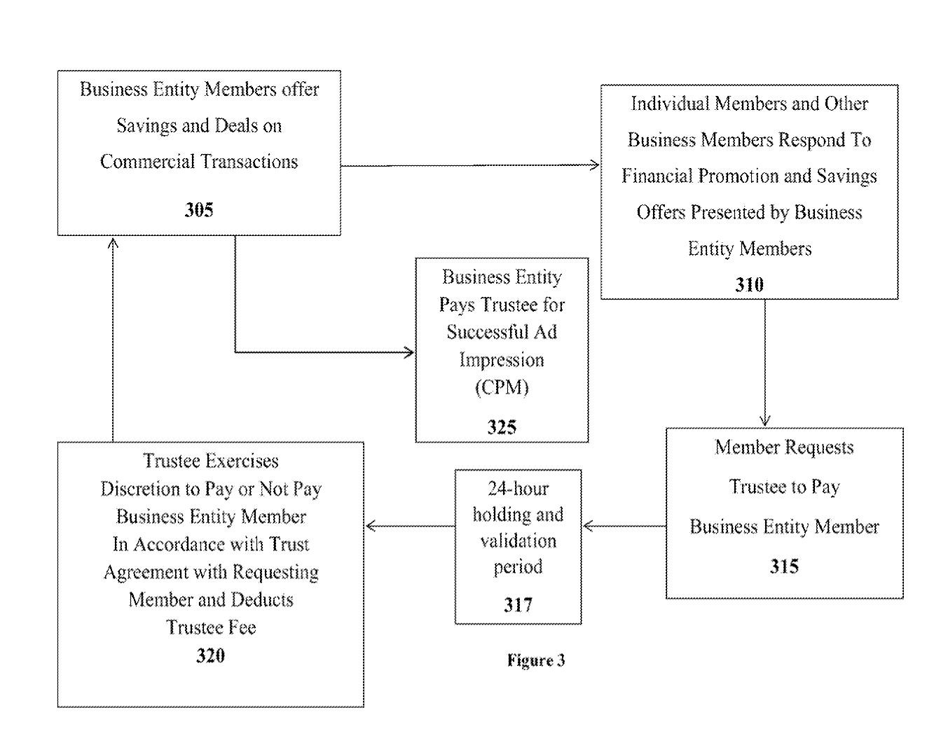

FIGS. 1-3 illustrate the steps of this online community using a trustee as the third party to consummate electronic transactions. As shown in FIG. 1, either an individual or a business entity may apply to join the community (100, 110) and provide appropriate information (105, 112) to populate a database regarding potential members of the community. Prospective members are vetted through a pre-qualification check and background or credit check (115, 120). Once accepted a digital signature is assigned by means known in the art (122,123). The newly accepted members accept a trust agreement that is particular to their state of residence or, business address (130). The trust agreement allows for a third party trustee to establish a trust account with a banking institution that in one embodiment is also a member of the community. Certain financial institutions require particular certifications to prove that the trustee has authority to conduct business via a respective trust account. The online community, therefore, is a trust network in that its members all have respective trust accounts managed by a qualified trustee, which may be the same trustee for more than one member.

The trust accounts of this invention may be funded by standard electronic commerce, check, or cash transactions known in the art. Members may also transfer money (any currency) into other members' accounts to fund the trust account (215).

One goal of the invention is to allow for electronic commerce via the online network of trust accounts. This is accomplished by business entity members offering promotions and deals to other members based on information filtered from the database of member information. Members respond to these targeted advertisements, and the trust manages a payment mechanism by which vendor members in the online community pay for successful ads (i.e. on a cost per thousand impressions basis).

The member who is the consumer in a transaction with a vendor in the online community requests that the respective trustee of the member's trust account provide payment for a selected transaction from the trust account. The trustee is in a unique position in that the trustee has an authority that a standard bank credit card or debit card issuer does not typically have. The trustee has real time access to immediately know the status of real funds in the trust account making all transactions via the online community essentially the same as cash transactions.

in order to give a consumer member from the online community time to reconsider a purchase or transaction, the system includes a validation or holding period of a predefined time for a transaction to be cancelled at no charge. For transactions that are consummated, the trustee is authorized, per the trust agreement, to deduct a trustee fee from each transaction.

The online community of this invention is implemented, via computerized networks, such as the Internet, and encompasses appropriate web based programming to facilitate electronic transfers. All security provisions will be according to regulations required by the financial community. The computerized trust account and electronic funds transfers may be implemented by software modules (referred to as trust account modules) on computer media, such as processors and the like. Similarly, a membership module may be programmed on a respective computer media as well. The computerized media are non-transitory computer readable media used for this kind of software development and include appropriate communications protocols to allow for members to connect via the electronic networks already available.

These and other aspects of the invention are set forth in the claims below.

What is claimed is:

1. A system for connecting individuals and business entities as members of an online community connected via a computerized network that enables electronic communications and electronic commerce among the members, the system comprising:
a trust account module and a membership module implemented by respective software on at least one non-transitory computer readable medium in electronic communication with the computerized network;
a database connected to said membership module for recording and accessing information regarding members of the online community;
a plurality of trust accounts corresponding to members of the online community and implemented by said trust account module, wherein funds within said trust accounts are accessible for disbursement only by a third party trustee.

2. A system according to claim 1, wherein said trust account module implements a payment request routine by which a member of the online community requests the third party trustee to make a payment to a different member of the online community with funds in said trust account.

3. A system according to claim 1, wherein said trust account module implements secure electronic funds transfers among members of the online community, wherein said transfers are approved and finalized by said third party trustee.

4. A system according to claim 1, wherein said membership module implements computer controlling commands allowing prospective members to complete, via electronic data entry, an application for a membership in the online community.

5. A system according to claim 4, wherein said application includes a plurality of selectable options identifying the kinds of offers that prospective individual members prefer to receive upon becoming a member of the online community.

6. A system according to claim 4, wherein said application includes a plurality of selectable options identifying the kinds of offers that prospective business entity members prefer to send upon becoming a member of the online community.

7. A system according to claim 4, wherein said membership module includes computer controlling commands to complete a qualifications check for a prospective member based on information provided on said application.

8. A system according to claim 1, wherein said trust accounts are governed by respective trust agreements entered by respective members of the online community and evidenced by certifications of trustees corresponding to financial institutions that are members of the online community.

9. A system according to claim 1, further comprising a communications module implemented by additional software on said computer readable medium, said communications module connecting members of the online community for bi-directional electronic data transfer.

10. A system according to claim 9, wherein said third party trustee receives requests for funds disbursement and communicates with a member making the request via said communications module.

11. A system according to claim 1, wherein said third party trustee is a common trustee for all members of the online community.

12. A method of establishing a trust network for financial transactions among members of an online community, said method comprising the following steps:
accepting members who have requested to join the online community:
establishing a respective trust agreement for each accepted member, wherein the trust agreement appoints a third party trustee to hold funds on behalf of the member named in the trust agreement;
creating a trust account in which legal title is held by said third party trustee on behalf of a member of the online community, said trust account governed by one of the respective trust agreements;
receiving funds for depositing into said trust account;
disbursing funds from said trust account only to members of the online community and only by an authorization of said third party trustee.

13. A method according to claim 12, further comprising the step of populating a database of information regarding individuals and business entities who complete an application to join the online community.

14. A method according to claim 13, further comprising the step of applying electronic filters to said database to target communications shared between members of the online community.

15. A method according to claim 14, further comprising the step of business entity members of the online community submitting targeted promotions to other members of the online community.

16. A method according to claim 15, further comprising the step of business entity members paying the third party trustee on a cost per thousand impressions basis for promotions sent to other members of the online community

17. A method according to claim 12, further comprising the step of a member of the online community requesting that a respective third party trustee execute a funds transfer from a respective trust fund to another member of the online community.

18. A method according to claim 17, further comprising the step of placing an electronic validation hold on the request for a predetermined time period.

19. A method according to claim 15, further comprising the step of the trustee disbursing funds from a trust fund to another member of the online community.

20. A method according to claim 12, further comprising the step of assigning the same third party trustee to all members of the online community.
